(19) United States
(12) Patent Application Publication
(10) Pub. No.: US 2015/0023770 A1
(43) Pub. Date: Jan. 22, 2015

(54) DISPENSING BULK TRAILER FOR CONVEYING AND UNLOADING ARTICLES

(71) Applicant: NORDCO INC., Oak Creek, WI (US)

(72) Inventor: Eric Charles Ergen, West Allis, WI (US)

(21) Appl. No.: 14/332,959

(22) Filed: Jul. 16, 2014

Related U.S. Application Data
(60) Provisional application No. 61/846,807, filed on Jul. 16, 2013.

(51) Int. Cl. B61C 13/00; B60P 1/16

(52) U.S. Cl. CPC B61C 13/00; B60P 1/16
USPC 414/483

(57) ABSTRACT

A detachable trailer for conveying and unloading articles in bulk is provided, including a frame configured for movement along a substrate and supporting generally vertically extending posts, a container mounted to the frame and configured for receiving the articles, the container being pivotally movable in a swinging action about a set of pivot points disposed at or adjacent each upper end of the posts. The posts and support arms defining a support structure for the container for supporting the pivoting action of the container when filled with the articles between a storage position and a delivery position. At least one powered cylinder is connected to the frame and to the container for pivoting the container about the pivot points associated with the posts for facilitating movement of the container from a rest or travel position, and an unloading position.

### RELATED APPLICATION

This application claims priority under 35 USC 119(e) from U.S. Provisional Application Ser. No. 61/846,807 filed Jul. 16, 2013.

### BACKGROUND

The present disclosure relates generally to railway maintenance equipment, and more specifically to a bulk storage trailer for conveying and unloading articles stored in bulk, such as railway fasteners or the like, to another railway maintenance machine.

Among various types of railway maintenance equipment, automatic spikers are known and used for driving railroad spikes into railroad ties for securing the rail to the tie plates and tie plates to the ties. The spiker is typically mounted on a spiking machine capable of traveling over railroad tracks and may be self-propelled or towable. Suitable examples of such spikers are disclosed in commonly owned U.S. Pat. Nos. 5,191,840 and 6,095,053, both of which are incorporated by reference.

During operation of conventional spikers, workers fill kegs with spikes held in a separate car or wagon, and load the filled kegs onto the spiking machine. A first worker then removes spikes from the keg, as needed, and places them in the spiker magazine. A second worker then operates the aiming and driving mechanism of the spiker to drive the spike where desired. This conventional system requires a large amount of manual labor to load the kegs with spikes and then load the kegs onto the spiking machine. In addition, manually reaching into the kegs to get the spikes wastes further time. Furthermore, space is limited on the spiking machine, so that only a few kegs can be carried on the spiking machine at one time. This limits the production capacity of the spiking machine

Another, improved system is disclosed in U.S. Pat. No. 7,216,590, incorporated by reference. In this system, a large spike storage bin or hopper is located on the rail spiker. A conveyor at the bottom of the hopper periodically delivers a supply of spikes from the hopper to an elevated tray where the spikes are easily accessed by operators. Upon receipt of the spikes from the tray, the operators load the spiker magazines by hand.

### SUMMARY

The present dispensing bulk trailer features a container for retaining bulk items such as railway fasteners, preferably spikes, and includes a lifting mechanism for pivoting the container so that the stored contents are dispensed into a desired location, such as an adjacent rail maintenance vehicle, preferably a spike driver. A retractable wedge located in one of the walls of the container is selectively operated to control the flow from the container as the container is lifted and tipped during a pivoting dispensing action.

More specifically, a detachable trailer for conveying and unloading articles in bulk, is provided, including a frame configured for movement along a substrate and supporting generally vertically extending posts, a container mounted to the frame and configured for receiving the articles, the container being pivotally movable in a swinging action about a set of pivot points disposed at or adjacent each upper end of the posts. The posts and support arms defining a support structure for the container for supporting the pivoting action of the container when filled with the articles between a storage position and a delivery position. At least one powered cylinder is connected to the frame and to the container for pivoting the container about the pivot points associated with the posts for facilitating movement of the container from a rest or travel position, and an unloading position.

In another embodiment, a bulk trailer being usable with a railway maintenance machine for conveying and unloading articles is provided, and includes a pivoting material container configured for receiving the articles, and being pivotable between an initial position and a fully extended position; and at least one wedge disposed on at least one side wall of the container, the wedge constructed and arranged to be pivotally mounted inside of the container for regulating a downward flow of the articles during a transition from the initial position and the fully extended position.

In yet another embodiment, a rail maintenance apparatus is provided for conveying and unloading railroad articles, and includes a framem, a container supported by the frame, the container configured for receiving the articles and having at least one wall provided with a wedge, the wedge constructed and arranged to rotatably alternate between an extended position and a retracted position for controlling a downward flow of the articles out of the container. At least one first cylinder associated with the container for pivoting same, and at least one second cylinder is associated with the wedge, wherein the second cylinder is connected at one end to the wedge and at an opposite end to the at least one wall.

### BRIEF DESCRIPTION OF THE DRAWINGS

Ha IA is a top perspective view of a bulk trailer in a first position connected to a spiking machine, incorporating the features of the present disclosure;

FIG. 1B is a side view of the bulk trailer of FIG. 1A;

FIG. 2A is a top perspective view of the bulk trailer in a second position;

FIG. 2B is a side view of the bulk trailer of FIG. 2A;

FIG. 3A is a top perspective view of the bulk trailer in a third position;

FIG. 3B is a side view of the bulk trailer of FIG. 3A;

FIG. 4A is a top perspective view of the bulk trailer in a fourth position;

FIG. 4B is an enlarged perspective view of the bulk trailer of FIG. 4A;

FIG. 4C is an enlarged side view of the bulk trailer of FIG. 4A; and

FIG. 5 is an exemplary circuit diagram of the bulk trailer of FIG. 1A.

### DETAILED DESCRIPTION

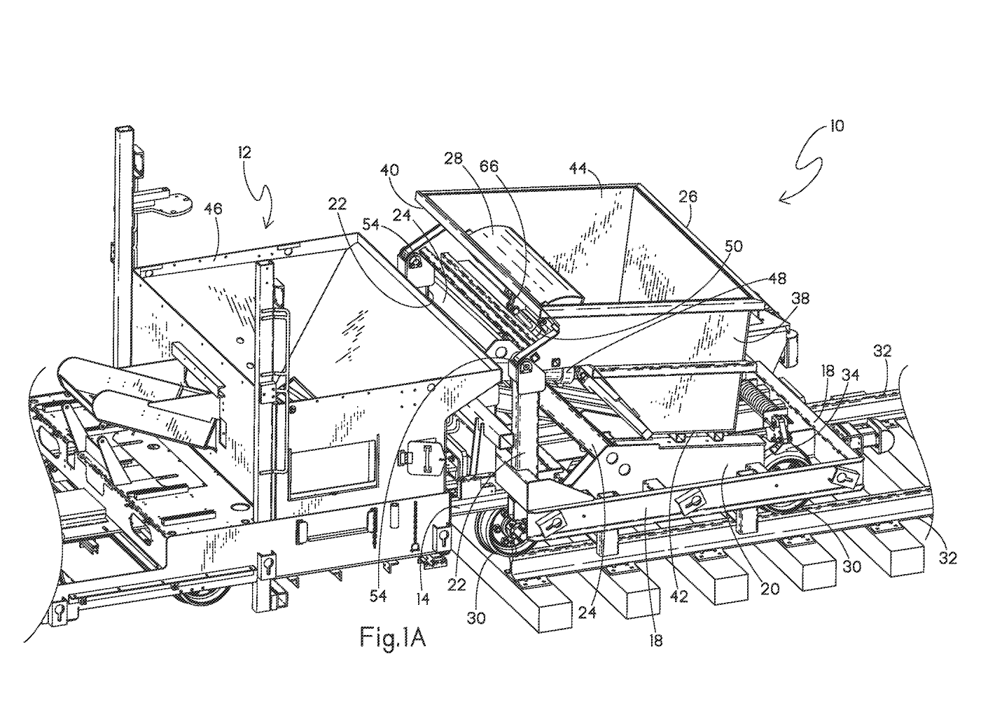

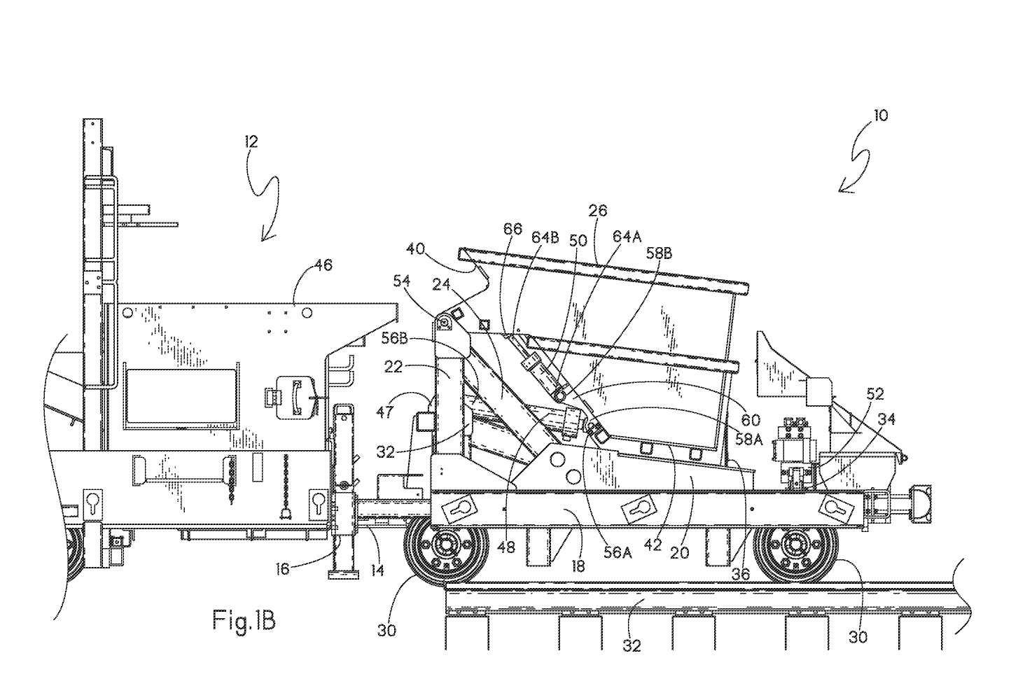

Referring now to FIGS. 1A-1B, a bulk trailer, generally designated 10, in a first position is shown on a portion of a railway maintenance spiking machine, generally designated 12. While the present bulk trailer 10 is contemplated as being usable with other railway maintenance machines, one such machine is disclosed in U.S. Pat. No. 7,216,590, incorporated by reference. The first position refers to an initial position of the bulk trailer 10 capable of holding articles, such as cut spikes, lag screws, anchors, screw spikes, clips, or the like (collectively referred to as spikes). As is well known in the art, the spiking machine 12 is designed to be self-propelled or towed as a separate unit alone or as part of a railway maintenance gang along a railroad track. While it is preferred that the bulk trailer 10 is towed by the spiking machine 12 via a hitch assembly 14, it is also contemplated that the present bulk trailer is self-propelled. It is also preferred that the hitch assembly 14 uses a short tow bar 16 to reduce the size of the assembly for maintaining close proximity between the bulk trailer 10 and the spiking machine 12. Further, having extra spikes in the proximity of the spiking machine 12, thereby avoiding insufficient supply of the spikes, maximizes the payload capacity without limiting productivity of the spiking machine.

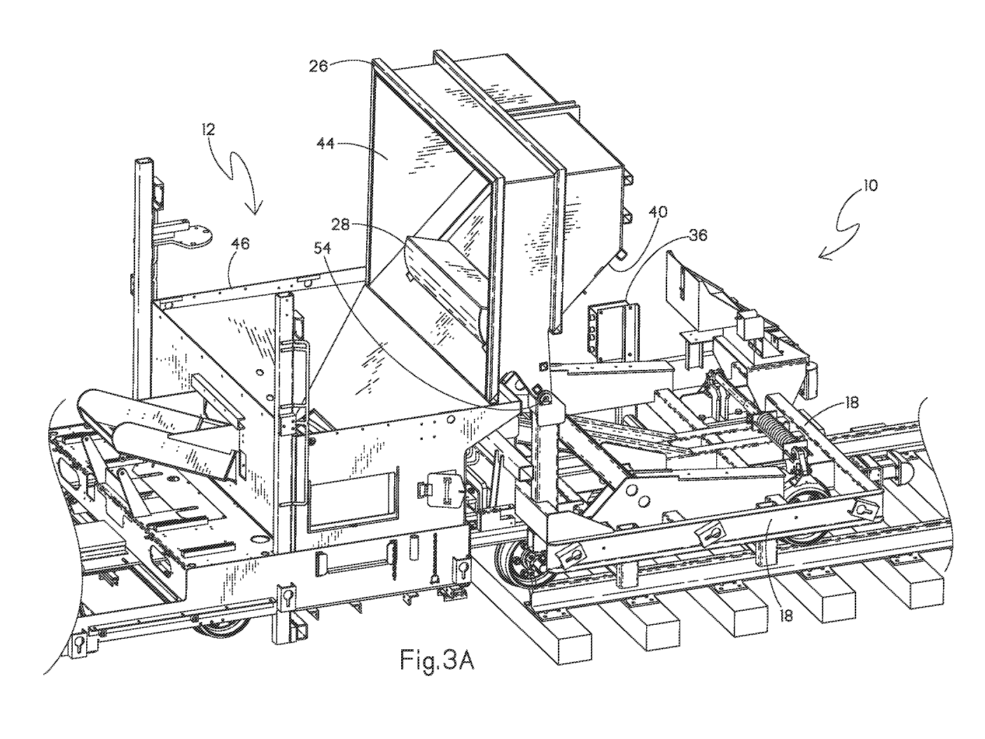

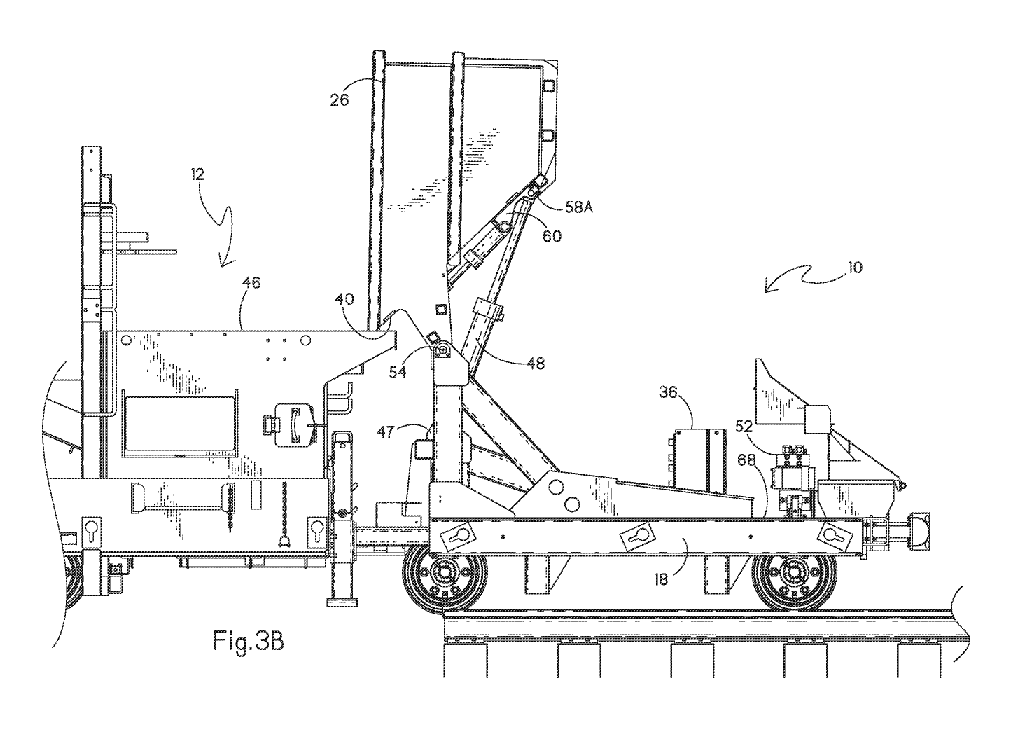

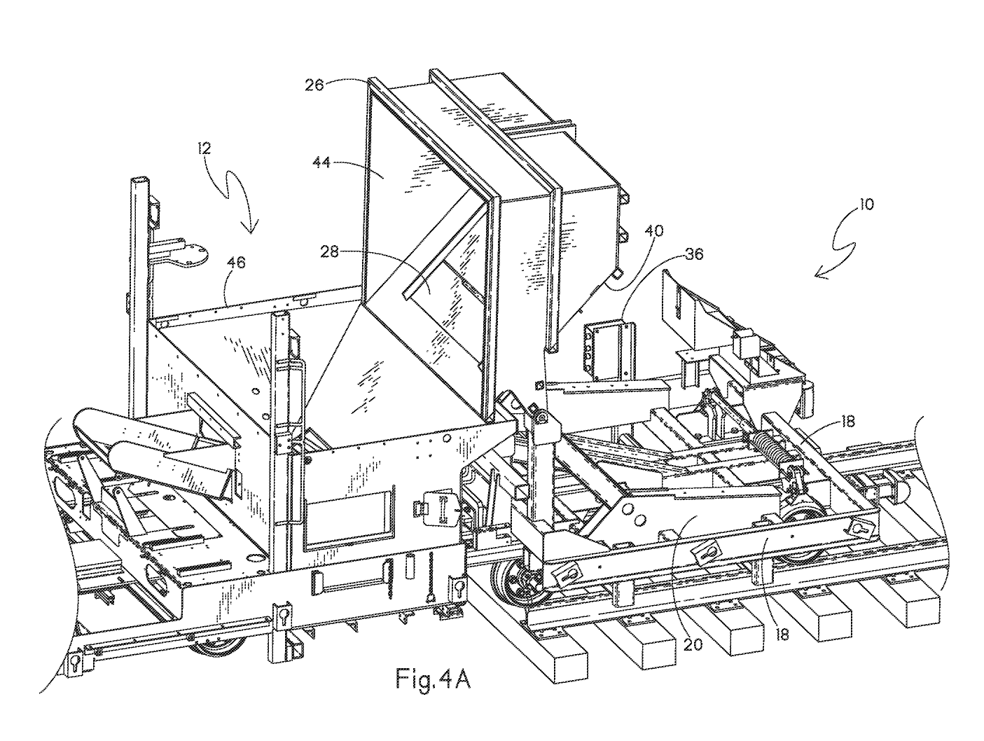

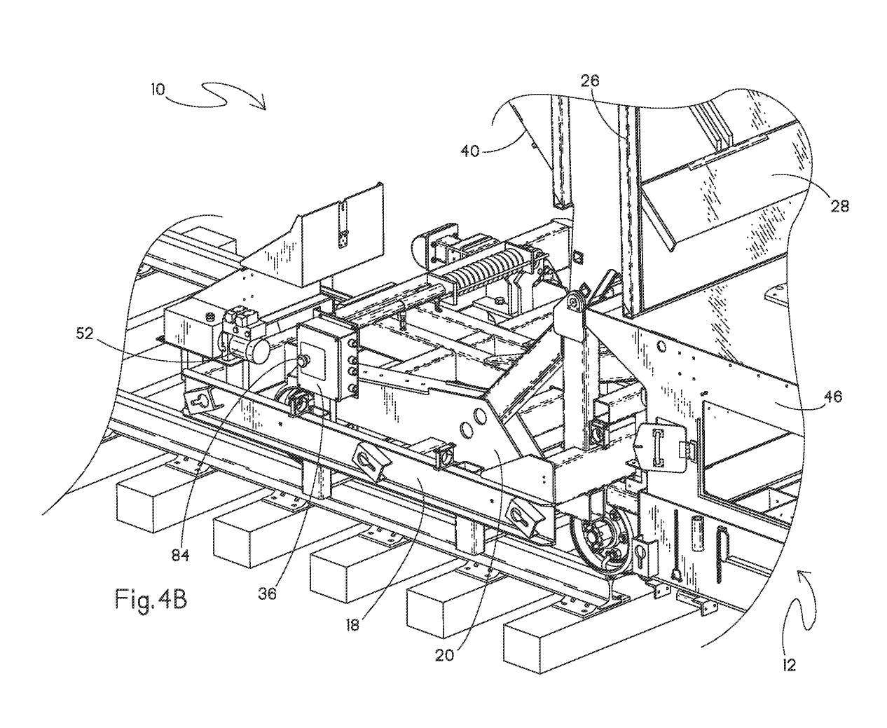

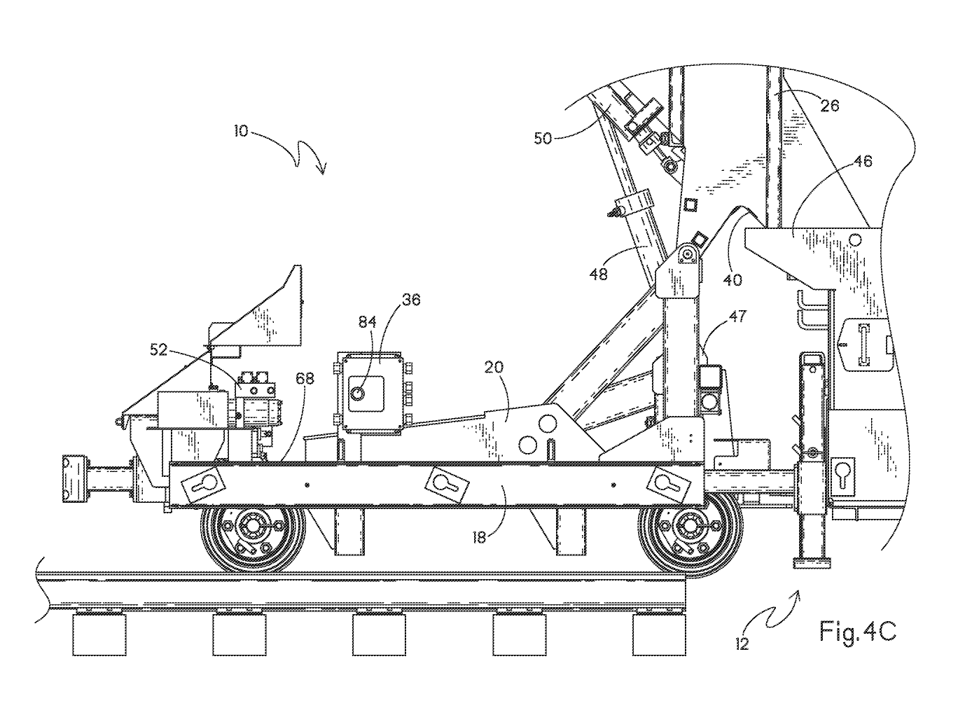

The bulk trailer 10 preferably includes a generally rectangular frame 18 supporting, among other things, a base 20, generally vertically extending posts 22, both the base and posts being connected to support arms 24, and a container 26 having a wedge 28. In the preferred embodiment, the base 20, posts 22 and support arms 24 define a support structure for the container 26 that is sufficiently strong for supporting a pivoting action of the container when filled with spikes between a storage or travel position (FIGS. 1A and 1B) and a spike delivery or unloading position (FIGS. 3A and 3B). A set of wheels 30 supports the frame 18 for traveling on a pair of rails 32 of the railroad track. While a two-axle frame trailer is shown, any number of axle(s) is also contemplated depending on the payload. A separate brake system 34 is installed on a rear axle to prevent the bulk trailer 10 from unwanted movement, such as while on a sloped area or when not connected to the spiking machine 12. It is preferred to receive electric current through a circuit control box 36 from the spiking machine 12 (shown better in FIGS. 4B and 4C), but it is also contemplated that a self-contained power source is optionally installed on the bulk trailer 10.

Initially, the spikes are deposited into the container 26, for example, by a payloader having an electromagnet or by other lifting devices known in the art. After depositing, the spikes are stored in the container 26 for a later use by the spiking machine 12. Until then, the spikes remain in the container 26 that rests within a space defined by the base 20. The container 26 preferably has a generally quadrilateral configuration with four side walls 38, including an inclined front wall 40, and a bottom 42. While the container 26 having a square-shaped opening is shown, other geometries of container opening and shape are also contemplated. An interior portion 44 of the container 26 is further defined by radially inwardly the inclined or sloping front wall 40. Optionally, a lid (not shown) is provided to cover the container 26.

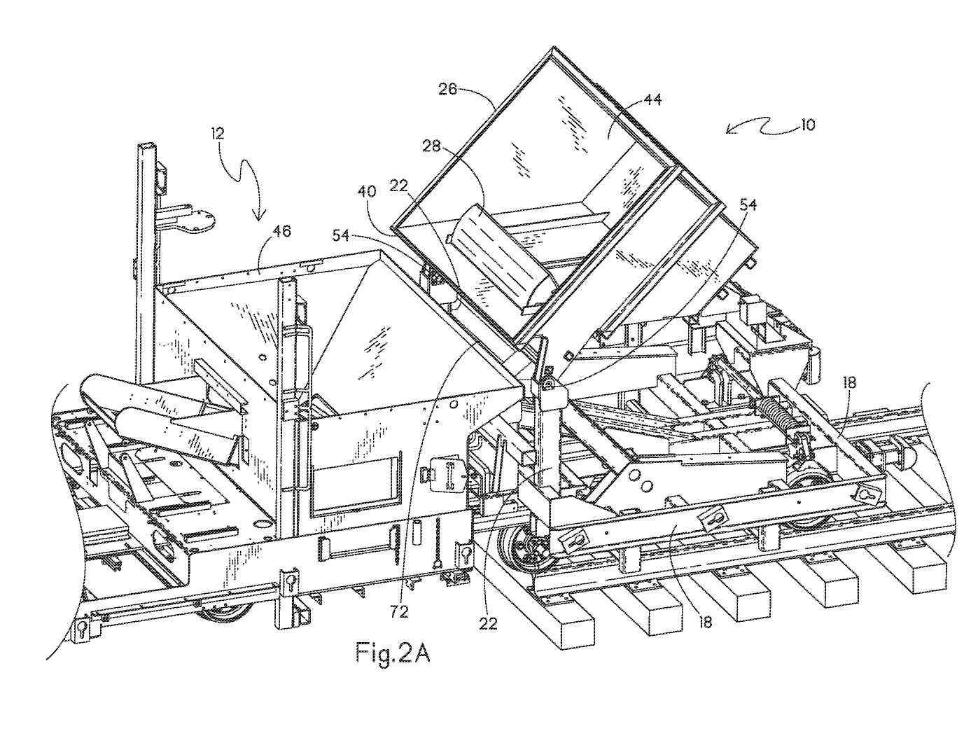

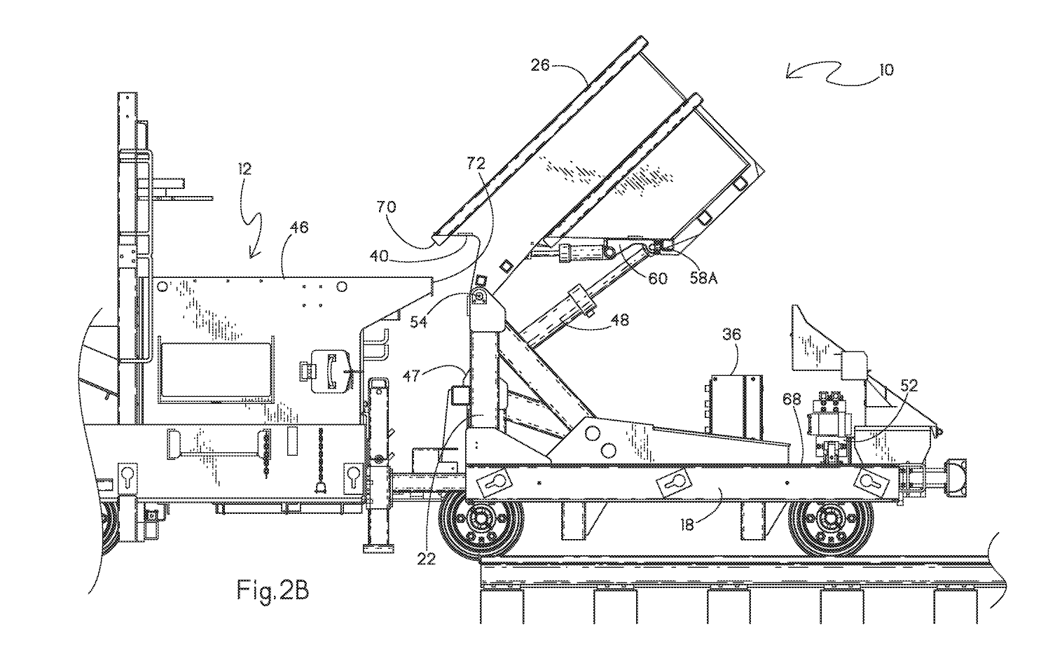

Referring now to FIGS. 2A and 2b, when the spiking machine 12 requires additional spikes during its operation, through use of the bulk trailer 10, additional spikes are supplied to the spiking machine without having to stop for loading additional kegs with spikes. Because the bulk trailer 10 having the container 26 is conveniently connected to the spiking machine 12, unloading of the spikes into a hopper 46 of the spiking machine is readily accommodated. To facilitate the unloading of the spikes, further included in the bulk trailer 10 are fluid power cylinders. At a generally horizontally-oriented crossbar 47 attached at each end to the vertical posts 22, at least one first cylinder 48 is associated with the container 26. Specifically, the first cylinder 48 is connected at one end to the crossbar 47 and at an opposite end to the container 26. In a preferred embodiment, the crossbar 47 is supported by and connected to the respective posts 22 at each opposite end using welding or the like to securely hold the crossbar mounted to the posts. Also, at least one second cylinder 50 is associated with the wedge 28 and is connected at one end to the wedge and at an opposite end to the front container wall 40.

One feature of the container 26 is a pivotal operation relative to the posts 22. In operation, the first and second cylinders 48, 50 are actuated by a fluid power control apparatus, generally designated 52 (FIG. 1B). The preferably hydraulic fluid power apparatus 52 selectively pressurizes the first cylinder 48 to pivotably lift and lower the container 26 in a swinging action about a set of pivot points such as pins 54 disposed at or adjacent each upper end of the posts 22.

Referring now to FIGS. 1B and 213, a first end 56A of the first cylinder 48 is secured to a first end 58A of a clevis flange or eyelet 60 on the front wall 40 of the container 26 near the bottom 42. A second end 56B of the first cylinder 48 is secured to a generally horizontally extending support beam 62 that is preferably disposed and sandwiched between the posts 22.

Another feature of the container 26 is that one of the side walls 38, preferably the front wall 40, is provided with the wedge 28 for regulating a downward flow of the spikes during the unloading process. While the wedge 28 disposed on the front wall 40 of the container 26 is shown, it is contemplated that the wedge 28 can be constructed and arranged to be pivotally mounted on any one of the side walls 38. Similarly, multiple wedges disposed on any of the walls 38 are also contemplated. The second cylinder 50 rotatably extends and retracts the wedge 28 under the action of the power apparatus 52. As described in detail below, extending and retracting the wedge 28 controls the flow of the spikes out of the container 26 when it is lifted upward for the unloading. A first end 64A of the second cylinder 50 is secured to a second end 58B of the clevis flange 60. A second end 64B of the second cylinder 50 is secured to a fin 66 (FIG. 1A) of the wedge 28.

It is contemplated that either the first ends 56A, 64A and the second ends 56B, 64B of the cylinders 48, 50 can be the rod ends, or the other corresponding ends will be the blind ends. While double acting cylinders 48, 50 are shown and described, it is contemplated that various pneumatic and other piston driven assemblies may be implemented with the present disclosure as is known to those skilled in the art.

Referring now to FIGS. 2A-2B, the bulk trailer 10 is shown in a second position. The second position refers to an intermediate position of the bulk trailer 10, where the front wall 40 of the container 26 is lifted upward by the first cylinder 48 such that the front wall is oriented in a substantially parallel and horizontal fashion relative to a plane 68 defined by the frame 18. When actuated, the first cylinder 48 extends, and rotates the container 26 about the pivot pins 54 preferably disposed on each end of the posts 22 by directly urging the first end 58A of the clevis flange 60 on the container.

At this time, the wedge 28 is still extended into the interior portion 44 of the container 26 (FIG. 2A), thereby preventing the spikes in the container from freely flowing into the hopper 46 of the spiking machine 12. Notably, although the spikes are meant to remain in the container 26 while the trailer 10 is in the second position, an edge 70 of the front wall 40 reaches over or at least abuts an adjoining edge 72 of the hopper 46 to prevent accidental overflow of the spikes from the container 6. Thus, an amount of spikes falling into the hopper 46 will be insignificant.

Referring now to FIGS. 3A-3B, the bulk trailer 10 is shown in a third position. The third position refers to a fully raised position of the bulk trailer 10, where the front wall 40 of the container 26 is lifted upward by full extension of the first cylinder 48 such that the front wall is oriented at an approximately 45 degree angle relative to the plane 68 defined by the frame 18. As in the second position, through extension, the first cylinder 48 rotates the container 26 about the pivot pins 54 by directly urging the first end 58A of the clevis flange 60, but the container is rotated more than in the second position.

Similarly with the second position, the wedge 28 is still extended, thereby preventing the spikes in the container 26 from freely flowing into the hopper 46 of the spiking machine 12. The flow of the spikes may be greater than in the second position due to a slope created by the front wall 40; however, the flow will be intermittent at best, thereby slowing the flows of the spikes out of the container 26.

Referring now to FIGS. 4A-4C, the bulk trailer 10 is shown in a fourth position. The fourth position refers to a final position of the bulk trailer 10, where, through retraction of the second cylinder 50, the wedge 28 is fully retracted to allow a free flow of the spikes into the hopper 46 of the spiking machine 12 while the front wall 40 of the container 26 is maintained at the approximately 45 degree angle relative to the plane 68 defined by the frame 18. During such operation, the second cylinder 50 rotatably retracts the wedge 28 for regulating the flow of the spikes. Although a fully retracted wedge is shown, a partially retracted wedge is contemplated for controlling the flow of the spikes. Likewise, partial retraction of the wedge 28 for a predetermined period is also contemplated. In this way, a heavy load of the spikes is not abruptly poured into the hopper 46, which might cause damage to the spiking machine 12. After completion of the unloading, the container 26 is lowered by the first cylinder 48 for resting on the base 20 and the bulk trailer 10 returns to the first position.

Although the various numbered positions were described separately above, it is contemplated that the delivery of the contents of the container 26 is moved gradually or smoothly from the rest position of FIG. 1B to the delivery position of FIG. 4A.

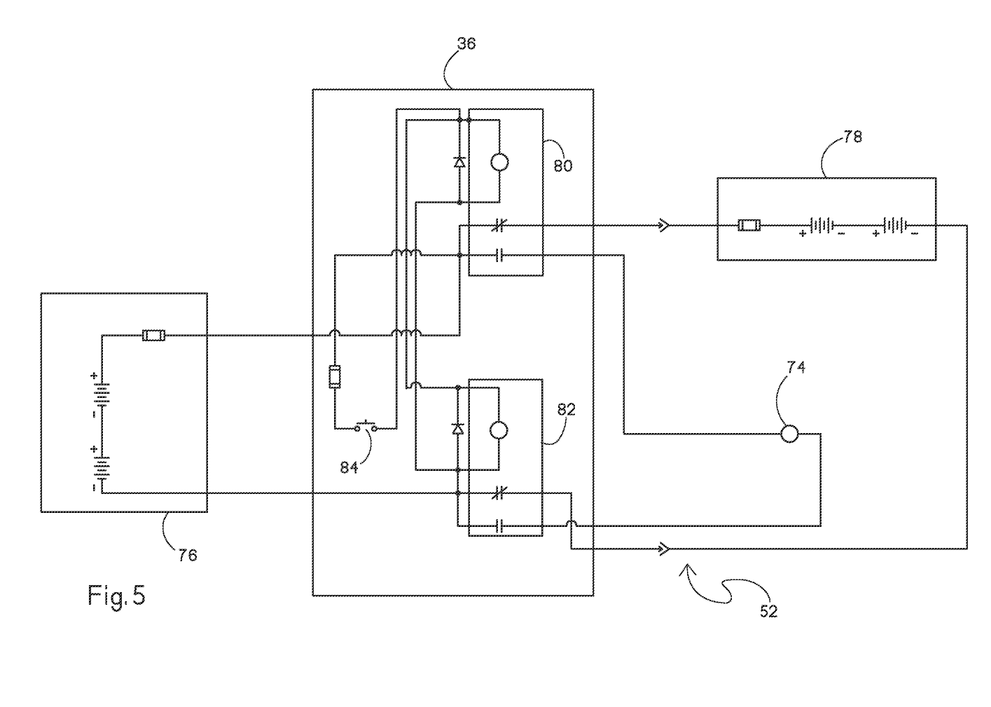

Referring now to FIGS. 4B, 4C and 5, an exemplary circuit diagram of the bulk trailer 10 is shown. As discussed above, the bulk trailer 10 preferably receives electric current through the circuit control box 36 from the spiking machine 12. The depicted circuit in the control box 36 controls the electric current applied to a motor 74 of the fluid power control apparatus 52. For example, the apparatus 52 includes the motor 74, a pump (not shown), a reservoir of hydraulic fluid (not shown), at least one control valve (not shown) and a power supply such as a first battery 76 on the hulk trailer 10. An additional battery 78 provides electric current for and is located on the spiking machine 12. Relays 80, 82 are provided in the control box circuit for selecting one of the two batteries 76,78 for powering the operation of the movement of the container 26 as described above. Although two different relays 80, 82 are shown for handling a maximum threshold amperage used in the bulk trailer 10, any number of relays is contemplated. During operation, for example, a push button 84 (FIGS. 4B and 4C) is activated to charge the trailer battery 76 from the spiking machine battery 78, and conversely is deactivated once the trailer battery is charged, for operating the hydraulic fluid power apparatus 52 for actuating the cylinders 48, 50. Although the push button 84 is operable by a user, an automatic switch is also contemplated based on sensor signals. It is also contemplated that the button 84 can be installed on other parts of the bulk trailer 10 or the spiking machine 12. An advantage of the circuit is that, during operation, the trailer 10 is not constantly drawing power from the main spiking machine battery 78.

While a particular embodiment of the present dispensing bulk trailer has been described herein, it will be appreciated by those skilled in the art that changes and modifications may be made thereto without departing from the present disclosure in its broader aspects and as reflected in the following claims.

1. A detachable trailer for conveying and unloading articles in bulk, comprising:
a frame configured for movement along a substrate and supporting generally vertically extending posts;
a container mounted to the frame and configured for receiving the articles, the container being pivotally movable in a swinging action about a set of pivot points disposed at or adjacent each upper end of the posts, the posts and support arms defining a support structure for the container for supporting the pivoting action of the container when filled with the articles between a storage position and a delivery position; and
at least one powered cylinder connected to the frame and to the container for pivoting the container about said pivot points associated with the posts for facilitating movement of the container from a rest or travel position, and an unloading position.

2. The detachable trailer of claim 1, wherein the plurality of powered cylinders includes at least one first cylinder associated with the container, the at least one first cylinder being connected at one end to a generally horizontally-oriented crossbar on said frame and at an opposite end to the container.

3. The detachable trailer of claim 1, wherein said container includes at least one pivotally operable wedge for regulating a downward flow of the articles during unloading of the articles from the container.

4. The detachable trailer of claim 3, further including at least one second cylinder associated with the container, connected at one end to the at least one wedge of the container and at an opposite end to a front wall of the container.

5. The detachable trailer of claim 3, wherein the at least one wedge is extended into an interior portion of the container while the trailer is in the second position for preventing the articles from freely flowing out of the container.

6. The detachable trailer of claim 1, wherein the pivotal movement of the container includes transitions between a first position, a second position, a third position, and a fourth position and said first position is an initial position of the trailer capable of holding the articles when the articles are deposited into the container.

7. The detachable trailer of claim 6, wherein the second position is an intermediate position of the trailer where a front wall of the container is lifted upward by the at least one first cylinder such that the front wall is oriented in a substantially parallel and horizontal fashion relative to a plane defined by the frame.

8. The detachable trailer of claim 7, wherein the third position is a fully raised position of the trailer where a front wall of the container is lifted upward by full extension of the at least one first cylinder such that the front wall is oriented at an approximately 45 degree angle relative to a plane defined by the frame.

9. The detachable trailer of claim 8, wherein the fourth position is a final position of the trailer where, through retraction of a second cylinder, at least one wedge is fully retracted to allow a free flow of the articles out of the container while a front wall of the container is maintained at an approximately 45 degree angle relative to a plane defined by the frame.

10. The detachable trailer of claim 4, wherein the at least one second cylinder rotatably selectively retracts and extends the at least one wedge for regulating a flow of the articles during the unloading of the articles from the container.

11. The detachable trailer of claim 4, wherein the at least one second cylinder partially or fully retracts and extends the at least one wedge for a predetermined period for preventing abrupt uploading of the articles.

12. The detachable trailer of claim 2, wherein the at least one first cylinder lowers the container for returning the trailer back to the first position,

13. The detachable trailer of claim 1, further comprising a circuit control box for controlling electric current supplied to the trailer, and a motor for controlling actuation of the at least one powered cylinder.

14. The detachable trailer of claim 1, further comprising a plurality of relays for selecting at least one power source for powering operational movement of the container.

15. A bulk trailer being usable with a railway maintenance machine for conveying and unloading articles, comprising:
a pivoting material container configured for receiving the articles, and being pivotable between an initial position and a fully extended position; and
at least one wedge disposed on at least one side wall of the container, the wedge constructed and arranged to be pivotally mounted inside of the container for regulating a downward flow of the articles during a transition from the initial position and the fully extended position.

16. The bulk trailer of claim 15, wherein pivotal movement of the container is performed by at least one first cylinder, and pivotal movement of the wedge is performed by at least one second cylinder.

17. The bulk trailer of claim 15, wherein the at least one wedge is extended into an interior portion of the container while the trailer is in an intermediate position for preventing the articles from freely flowing out of the container.

18. The bulk trailer of claim 15, wherein the at least one wedge is fully retracted outside of the container while the trailer is in a final position to allow a free flow of the articles out of the container.

19. A rail maintenance apparatus for conveying and unloading railroad articles, comprising:
a frame;
a container supported by the frame, the container configured for receiving the articles and having at least one wall provided with a wedge, the wedge constructed and arranged to rotatably alternate between an extended position and a retracted position for controlling a downward flow of the articles out of the container;
at least one first cylinder associated with the container for pivoting same; and
at least one second cylinder associated with the wedge, wherein the second cylinder is connected at one end to the wedge and at an opposite end to the at least one wall.

20. The rail maintenance apparatus of claim 19, wherein the wedge is in the extended position while the container is in a first position, a second position, and a third position, but the wedge is in the retracted position while the container is in a fourth position.
